(19) United States
(12) Patent Application Publication
(10) Pub. No.: US 2023/0028889 A1
(43) Pub. Date: Jan. 26, 2023

(54) METHOD AND APPARATUS FOR ALLOCATING SIDELINK RESOURCE IN WIRELESS COMMUNICATION SYSTEM

(71) Applicant: ELECTRONICS AND TELECOMMUNICATIONS RESEARCH INSTITUTE, Daejeon (KR)

(72) Inventors: Tae Hyoung KIM, Daejeon (KR); Jun Hyeong KIM, Daejeon (KR); Go San NOH, Daejeon (KR); Il Gyu KIM, Daejeon (KR); Hee Sang CHUNG, Daejeon (KR); Dae Soon CHO, Daejeon (KR); Sung Woo CHOI, Daejeon (KR); Seung Nam CHOI, Daejeon (KR)

(21) Appl. No.: 17/864,712

(22) Filed: Jul. 14, 2022

(30) Foreign Application Priority Data
Jul. 14, 2021 (KR) 10-2021-0092525
Jul. 14, 2022 (KR) 10-2022-0087111

(51) Int. Cl. H04W 72/12; H04W 74/08

(52) U.S. Cl. CPC H04W 72/1231; H04W 72/1278; H04W 74/0816

(57) ABSTRACT

Disclosed are a method and an apparatus for sidelink resource allocation in a wireless communication system. The method and apparatus for sidelink resource allocation in a wireless communication system, a method of a first terminal, may include: receiving, from a base station, resource pool configuration information including information on a resource sensing type; in response to that the information on the resource sensing type indicates a sensing operation, sensing transmission resource(s) within a sensing period according to the resource sensing type based on the scheduling information; selecting a first resource based on a result of the sensing on the transmission resource(s); and performing sidelink communication using the selected first resource.

### CROSS-REFERENCE TO RELATED APPLICATIONS

This application claims priority to Korean Patent Applications No. 10-2021-0092525, filed on Jul. 14, 2021, and No. 10-2022-0087111, filed on Jul. 14, 2022, with the Korean Intellectual Property Office (KIPO), the entire contents of which are hereby incorporated by reference.

### BACKGROUND

### 1. Technical Field

The present disclosure relates to a sidelink communication technique in a wireless communication system, and more particularly, to a technique for allocating sidelink resources.

### 2. Description of Related Art

The communication system (hereinafter, a New Radio (NR) communication system) using a higher frequency band (e.g., a frequency band of 6 GHz or higher) than a frequency band (e.g., a frequency band of 6 GHz or lower) of the Long Term Evolution (LTE) (or, LTE-A) communication system is being considered for processing of soaring wireless data. The NR communication system may support not only a frequency band below 6 GHz but also 6 GHz or higher frequency band, and may support various communication services and scenarios as compared to the LTE communication system. In addition, the requirements of the NR communication system may include enhanced mobile broadband (eMBB), ultra-reliable low-latency communication (URLLC), massive machine type communication (mMTC), and the like.

Sidelink communication may be performed in the NR system. The sidelink communication may be performed based on a resource allocation mode 1 or a resource allocation mode 2. When the sidelink resource allocation mode 1 is used, sidelink communication may be performed using a resource scheduled by a base station. When the sidelink resource allocation mode 2 is used, sidelink communication may be performed using a resource selected by a terminal. In this case, there is a need for a method for the terminal to efficiently sense and/or select the resource.

### SUMMARY

In order to solve the above-identified problems, exemplary embodiments of the present disclosure are directed to providing a method and an apparatus for allocating sidelink resources in a wireless communication system.

A method for allocating sidelink resources in a wireless communication system, performed by a first terminal, according to a first exemplary embodiment of the present disclosure for achieving the above-described objective, may comprise: receiving, from a base station, resource pool configuration information including information on a resource sensing type; in response to that the information on the resource sensing type indicates a sensing operation, measuring a received power of a physical sidelink control channel (PSCCH); in response to that the received power of the PSCCH is equal to or greater than a threshold value, receiving, from a second terminal, sidelink control information (SCI) including scheduling information; sensing transmission resource(s) within a sensing period according to the resource sensing type based on the scheduling information and a measurement result of the received power; selecting a first resource based on a result of the sensing on the transmission resource(s); and performing sidelink communication using the selected first resource.

The resource pool configuration information may further include information on at least one period value associated with the sensing period, and the sensing of the transmission resource(s) within the sensing period according to the resource sensing type based on the scheduling information and the measurement result of the received power may comprise: in response to that the information on the resource sensing type indicates periodic-based partial sensing, performing resource sensing partially within the sensing period based on the at least one period value.

The resource pool configuration information may further include information on at least one period value associated with the sensing period and information on a number of sensing slots associated with each of the at least one period value, and the sensing of the transmission resource(s) within the sensing period according to the resource sensing type based on the scheduling information and the measurement result of the received power may comprise: in response to that the information on the resource sensing type indicates periodic-based partial sensing, performing resource sensing partially within the sensing period based on the at least one period value and the number of sensing slots associated with each of the at least one period value.

The method may further comprise, after the selecting of the first resource based on the result of the sensing on the transmission resource(s), performing a re-evaluation operation on the first resource, wherein the re-evaluation operation may be performed in a time period associated with a minimum value of the at least one period value and a slot of the first resource.

The resource pool configuration information may further include information on a first value and a second value indicating a sensing period, and the sensing of the transmission resource(s) within the sensing period according to the resource sensing type based on the scheduling information and the measurement result of the received power may comprise: in response to that the information on the resource sensing type indicates contiguous partial sensing, performing resource sensing continuously within a first slot associated with the first value to a second slot associated with the second value.

The method may further comprise, after the selecting of the first resource based on the result of the sensing on the transmission resource(s), performing a re-evaluation operation on the first resource, wherein the re-evaluation operation may be a contiguous partial sensing operation on the first resource.

The method may further comprise, when the SCI includes information on a second resource selected by the second terminal and information on a priority of the second terminal, in response to that the information on the resource sensing type indicates random resource selection, arbitrarily selecting a third resource; determining whether a collision exists between the second resource and the third resource; and in response to determining that a collision exists between the second resource and the third resource and a preset priority of the first terminal is lower than the priority of the second terminal, selecting a fourth resource different from the third resource, wherein the priority of the second terminal is associated with whether or not the second terminal performs sensing.

The method may further comprise, when the SCI includes information on a second resource selected by the second terminal and an indicator of whether or not the second terminal performs sensing, in response to that the information on the resource sensing type indicates random resource selection, arbitrarily selecting a third resource; determining whether a collision exists between the second resource and the third resource; and in response to determining that a collision exists between the second resource and the third resource and the indicator indicates that the second resource is a resource selected by the random resource selection, selecting a fourth resource different from the third resource.

A first terminal for allocating sidelink resources in a wireless communication system, according to a second exemplary embodiment of the present disclosure for achieving the above-described objective, may comprise: a processor; and a memory storing one or more instructions executable by the processor, wherein the one or more instructions are executed to: receive, from a base station, resource pool configuration information including information on a resource sensing type; in response to that the information on the resource sensing type indicates a sensing operation, measure a received power of a physical sidelink control channel (PSCCH); perform monitoring on the PSCCH based on the resource pool configuration information; in response to that the received power of the PSCCH is equal to or greater than a threshold value, receive, from a second terminal, sidelink control information (SCI) including scheduling information; sense transmission resource(s) within a sensing period according to the resource sensing type based on the scheduling information and a measurement result of the received power; select a first resource based on a result of the sensing on the transmission resource(s); and perform sidelink communication using the selected first resource.

The resource pool configuration information may further include information on at least one period value associated with the sensing period, and when the information on the resource sensing type indicates periodic-based partial sensing and the transmission resource(s) is sensed within the sensing period based on the scheduling information and the measurement result of the received power, the periodic-based partial sensing may be performed within the sensing period based on the at least one period value.

The resource pool configuration information may further include information on at least one period value associated with the sensing period and information on a number of sensing slots associated with each of the at least one period value, and when the information on the resource sensing type indicates periodic-based partial sensing and the transmission resource(s) is sensed within the sensing period based on the scheduling information and the measurement result of the received power, the periodic-based partial sensing may be performed within the sensing period based on the at least one period value and the number of sensing slots associated with each of the at least one period value.

The one or more instructions may be further executed to, after the selecting of the first resource based on the result of the sensing on the transmission resource(s), perform a re-evaluation operation on the first resource, wherein the re-evaluation operation may be performed in a time period associated with a minimum value of the at least one period value and a slot of the first resource.

The resource pool configuration information may further include information on a first value and a second value indicating a sensing period, and when the information on the resource sensing type indicates contiguous-based partial sensing and the transmission resource(s) is sensed within the sensing period based on the scheduling information and the measurement result of the received power, the contiguous partial sensing may be performed within a first slot associated with the first value to a second slot associated with the second value.

The one or more instructions may be further executed to, after the selecting of the first resource based on the result of the sensing on the transmission resource(s), perform a re-evaluation operation on the first resource, wherein the re-evaluation operation may be a contiguous partial sensing operation on the first resource.

The SCI may include information on a second resource selected by the second terminal and information on a priority of the second terminal, and the one or more instructions may be further executed to: in response to that the information on the resource sensing type indicates random resource selection, arbitrarily select a third resource; determine whether a collision exists between the second resource and the third resource; and in response to determining that a collision exists between the second resource and the third resource and a preset priority of the first terminal is lower than the priority of the second terminal, select a fourth resource different from the third resource, wherein the priority of the second terminal is associated with whether or not the second terminal performs sensing.

The SCI may include information on a second resource selected by the second terminal and an indicator of whether or not the second terminal performs sensing, and the one or more instructions may be further executed to: in response to that the information on the resource sensing type indicates random resource selection, arbitrarily select a third resource; determine whether a collision exists between the second resource and the third resource; and in response to determining that a collision exists between the second resource and the third resource and the indicator indicates that the second resource is a resource selected by the random resource selection, select a fourth resource different from the third resource.

According to the present disclosure, provided is a signaling method required for a terminal operating in the sidelink resource allocation mode 2 in a vehicle-to-everything (V2X) communication environment.

In addition, according to the present disclosure, the terminal operating in the sidelink resource allocation mode 2 in the V2X communication environment can efficiently perform resource sensing and/or resource selection.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating a first exemplary embodiment of a Vehicle-to-Everything (V2X) communication system.

FIG. 4 is a conceptual diagram illustrating a first exemplary embodiment of a method for configuring a resource sensing window and/or a resource selection window in the sidelink resource allocation mode 2.

FIG. 5 is a flowchart illustrating a first exemplary embodiment of a procedure performed by a terminal operating in the sidelink resource allocation mode 2.

FIG. 6 is a conceptual diagram illustrating a first exemplary embodiment of a two-stage SCI structure.

FIG. 7 is a conceptual diagram illustrating a first exemplary embodiment of a part of a resource sensing and/or resource selection procedure of a terminal operating in the sidelink resource allocation mode 2.

FIG. 8 is a conceptual diagram illustrating a first exemplary embodiment of a periodic-based partial sensing method.

FIG. 9 is a conceptual diagram illustrating a first exemplary embodiment of a sensing method for resource re-evaluation and/or pre-emption check.

FIG. 10 is a conceptual diagram illustrating a first exemplary embodiment of a contiguous partial sensing method.

FIG. 11 is a conceptual diagram illustrating a first exemplary embodiment of a random resource selection method.

### DETAILED DESCRIPTION OF THE EMBODIMENTS

A communication system to which exemplary embodiments according to the present disclosure are applied will be described. A communication system to which exemplary embodiments according to the present disclosure are applied is not limited to the content described below, and exemplary embodiments according to the present disclosure may be applied to various communication systems. Here, a communication system may be used in the same meaning as a communication network.

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced (LTE-A) network, 5G mobile communication network, or the like.

Throughout the present disclosure, a terminal may refer to a mobile station, mobile terminal, subscriber station, portable subscriber station, user equipment, an access terminal, or the like, and may include all or a part of functions such as the terminal, mobile station, mobile terminal, subscriber station, mobile subscriber station, user equipment, access terminal, or the like.

The above-described terminal may mean various devices having communication capability, which a user of a mobile communication service can use, such as a desktop computer, laptop computer, tablet PC, wireless phone, mobile phone, smart phone, smart watch, smart glass, virtual reality (VR) glass, e-book reader, portable multimedia player (PMP), portable game console, navigation device, digital camera, digital multimedia broadcasting (DMB) player, digital audio recorder, digital audio player, digital picture recorder, digital picture player, digital video player, or the like.

Throughout the present disclosure, the base station may refer to an access point, radio access station, node B, evolved node B (eNodeB), base transceiver station, mobile multihop relay (MMR)-BS, or the like, and may include all or part of functions such as the base station, access point, radio access station, nodeB, eNodeB, base transceiver station, and MMR-BS.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, as an example of a wireless access system for which exemplary embodiments of the present disclosure can be used, a 3rd generation partnership project (3GPP) NR system as well as a 3GPP LTE/LTE-A system may be described. Hereinafter, in order to clarify the description of the present disclosure, the description is based on the 3GPP communication system (e.g., LTE, NR, 6G, etc.), but the technical spirit of the present disclosure is not limited thereto.

The following techniques may be used in various access communication systems such as code division multiple access (CDMA), frequency division multiple access (FDMA), time division multiple access (TDMA), orthogonal frequency division multiple access (OFDMA), and single carrier frequency division multiple access (SC-FDMA).

A communication system or a memory system to which exemplary embodiments according to the present disclosure are applied will be described. A communication system or a memory system to which exemplary embodiments according to the present disclosure are applied is not limited to the contents described below, and exemplary embodiments according to the present disclosure may be applied to various communication systems. Here, a communication system may be used in the same meaning as a communication network.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

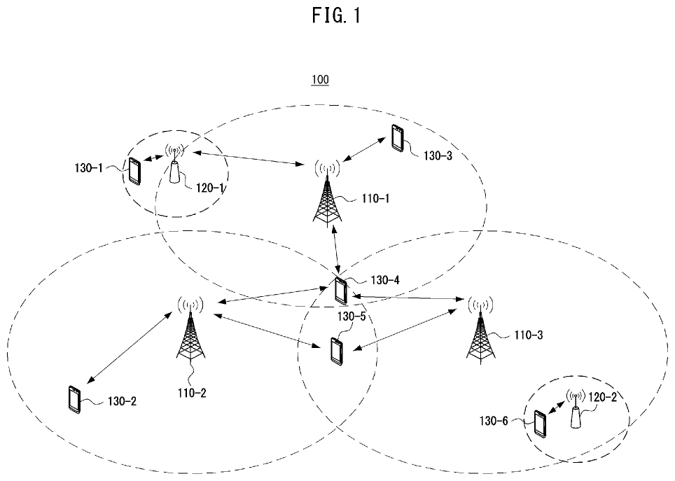

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 gigahertz (GHz) or below, and the 5G communication may be performed in a frequency band of 6 GHz or above. Also, the 6G communication may be performed in a terahertz (THz) frequency band.

For example, for the 4G, 5G, and/or 6G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

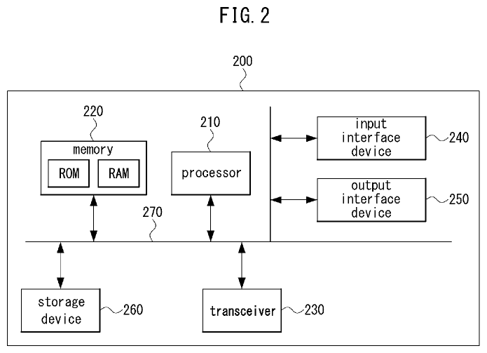

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, a small base station, a small cell base station, a femto cell base station, a micro cell base station, a picocell base station, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g., a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Also, each of the plurality of base stations 110-1, 110-2, 110-3, 120-1, and 120-2 may support multi-input multi-output (MIMO) transmission (e.g., a single-user MIMO (SU-MIMO), multi-user MIMO (MU-MIMO), multi-cell MIMO, massive MIMO, or the like), adaptive MIMO switching (AMS), coordinated multipoint (CoMP) transmission, carrier aggregation (CA) transmission, unlicensed band transmission, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

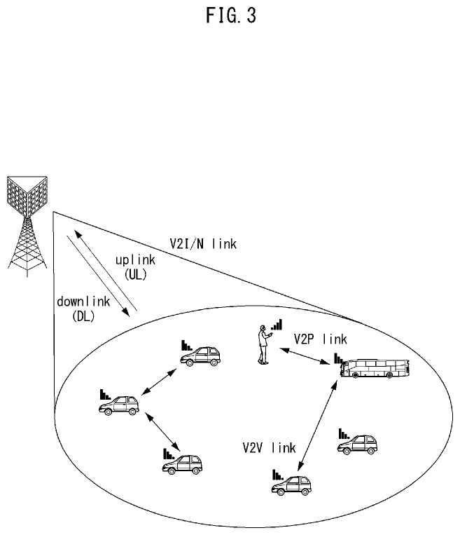

FIG. 3 is a conceptual diagram illustrating a first exemplary embodiment of a Vehicle-to-Everything (V2X) communication system.

Referring to FIG. 3, the V2X may refer to a communication technology for exchanging various information including traffic information, etc. with other vehicles and objects on which infrastructures are constructed such as roads through a wired network and/or a wireless network. The V2X may include vehicle-to-vehicle (V2V) communication, vehicle-to-infrastructure/network (V2I/N) communication, and/or vehicle-to-pedestrian (V2P) communication. As an example of the V2X communication, vehicles within a certain range may prevent sudden traffic accidents by exchanging location and/or speed information and surrounding traffic information through V2V communication. In addition, it is possible to provide a platooning service in which a plurality of vehicles connected by V2V communication run in succession on a highway. In addition, a high-speed wireless backhaul service is provided to a vehicle through V2I/N communication so that users in the vehicle can use high-speed Internet services, and the users can remotely drive and/or control the vehicle using a V2I/N wireless network.

In various wireless communication systems including the LTE communication system, a D2D communication scheme, which is a scheme of direct communication between terminals without going through a network node, has been adopted in order to support the aforementioned V2X services and various other wireless communication services. A direct communication link between terminals may be referred to as a sidelink. In the case of the LTE communication system, communication between terminals through a sidelink may be possible even when a terminal is out of a network coverage, and the LTE sidelink may be used for D2D communication. In addition, there have been many efforts to improve a sidelink to be suitable for V2X communication.

In addition to the existing LTE-based V2X services, an NR V2X may support improved V2X services, complement the LTE V2X services rather than replacing the services provided by the LTE V2X, and support the improved V2X services by interworking with the LTE V2X. Therefore, the NR V2X may have to satisfy higher requirements than the LTE V2X. The NR V2X technology may focus on sidelink design. As described above, the sidelink may refer to a communication link capable of exchanging data packets directly between terminals without going through a network. The sidelink may include not only a V2V link and a V2P link as shown in FIG. 3 but also a V2I link with an infrastructure supporting functions of vehicles and terminals. In addition, in the V2X, in addition to broadcast-based sidelink communication, unicast-based and groupcast-based sidelink communications for more various V2X services may be supported. As an example, the NR V2X system may directly exchange messages between terminals through unicast communication, and a terminal within or outside a group may transmit a message to terminals belonging to the group through groupcast communication.

In sidelink communication (e.g., NR-V2X sidelink communication), a transmission resource may be allocated based on a sidelink resource allocation mode 1 or a sidelink resource allocation mode 2. When the sidelink resource allocation mode 1 is used, a base station may allocate a sidelink resource to be used for data transmission within a resource pool to a transmitting terminal. In addition, when the sidelink resource allocation mode 1 is used, the transmitting terminal may transmit data to a receiving terminal using the sidelink resource allocated by the base station. Here, the transmitting terminal may refer to a terminal transmitting data in sidelink communication, and the receiving terminal may be a terminal receiving the data in sidelink communication.

When the sidelink resource allocation mode 2 is used, a transmitting terminal may autonomously select a sidelink resource to be used for data transmission within a resource pool by performing a resource sensing operation and/or a resource selection operation. The base station may configure a resource pool for the sidelink resource allocation mode 1 and a resource pool for the sidelink resource allocation mode 2 to terminal(s). The resource pool for the sidelink resource allocation mode 1 may be configured independently of the resource pool for the sidelink resource allocation mode 2. Alternatively, a common resource pool may be configured for the sidelink resource allocation mode 1 and the sidelink resource allocation mode 2. Meanwhile, in the sidelink resource allocation mode 2, which is a scheme of communicating only through a sidelink without control of the base station, a resource sensing technique and/or a resource selection technique for a sidelink resource allocated to a terminal may be the most important.

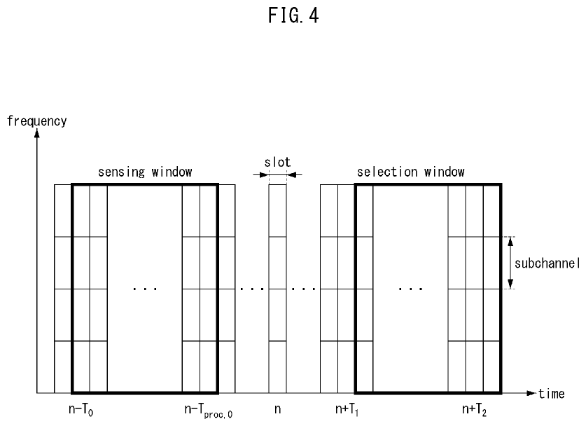

FIG. 4 is a conceptual diagram illustrating a first exemplary embodiment of a method for configuring a resource sensing window and/or a resource selection window in the sidelink resource allocation mode 2.

Referring to FIG. 4, a resource pool in which transmission and reception is performed in a sidelink may be configured as slot(s) in the time domain, and configured as subchannel(s) (e.g., resource block (RB) set(s)) in the frequency domain. A terminal operating in the resource allocation mode 2 may perform resource sensing and/or resource selection. For example, it may be assumed that the terminal operating in the sidelink resource allocation mode 2 receives a resource selection trigger in a slot n. When the terminal operating in the resource allocation mode 2 receives the resource selection trigger in the slot n, and thus a resource selection operation is triggered in the slot n, the terminal may perform resource sensing in a time period (e.g., slots [n−T₀, n−T_{proc,0}] in FIG. 2) corresponding to a resource sensing window, and based on a result of the resource sensing, may select a resource for transmission within a time window (e.g., slots [n+T₁, n+T₂] in FIG. 2) corresponding to a resource selection window.

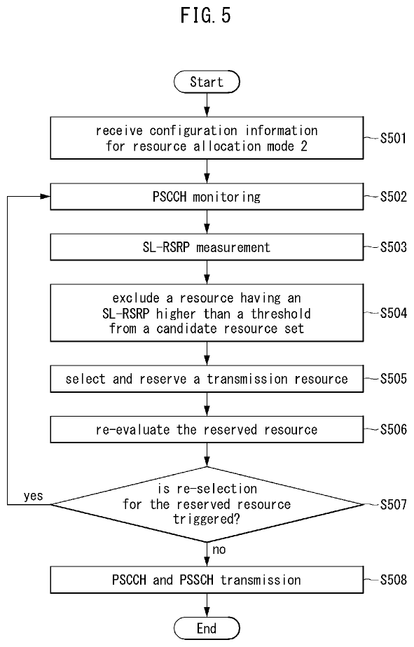

FIG. 5 is a flowchart illustrating a first exemplary embodiment of a procedure performed by a terminal operating in the sidelink resource allocation mode 2.

Referring to FIG. 5, a terminal may receive configuration information for the resource allocation mode 2 from a higher layer of a base station (S501). The configuration information may include at least one of resource pool configuration information, priority information, data packet delay budget information, resource reservation interval information, candidate resource set information, resource selection window size information, resource sensing window size information, received power (e.g., reference signal received power (RSRP)) threshold information, or combinations thereof. The configuration information may include various parameters required for resource selection and/or resource sensing in addition to the above-described information. The terminal may continuously perform monitoring on a physical sidelink control channel (PSCCH) corresponding to a sidelink control channel (S502). After performing the PSCCH monitoring, the terminal may determine that a PSCCH has been transmitted if an RSRP of a PSCCH demodulation reference signal (DMRS) is equal to or greater than a threshold value. In this case, the terminal may receive sidelink control information (SCI) and may identify resource allocation and/or scheduling information included in the SCI. The terminal may detect a DMRS of a physical sidelink shared channel (PSSCH) from a resource indicated by the resource allocation information, and may measure an RSRP of the DMRS of the PSSCH (S503). After measuring the RSRP, the terminal may exclude a resource having an RSRP higher than a preset threshold from a preconfigured candidate resource set (S504). The terminal may select and/or reserve a resource to be used for transmission from among the remaining resources except the resource excluded from the preconfigured candidate resource set (S505). After the terminal selects and/or reserves the resource to be used for transmission, the terminal may re-evaluate the reserved resource (S506). After the terminal re-evaluates the reserved resource, the terminal may determine whether re-selection for the reserved resource is triggered (S507). If re-selection for the reserved resource is triggered, the terminal may perform PSCCH monitoring again from the step S502. If re-selection for the reserved resource is not triggered, the terminal may perform PSCCH and/or PSSCH transmission using the reserved resource as it is (S508).

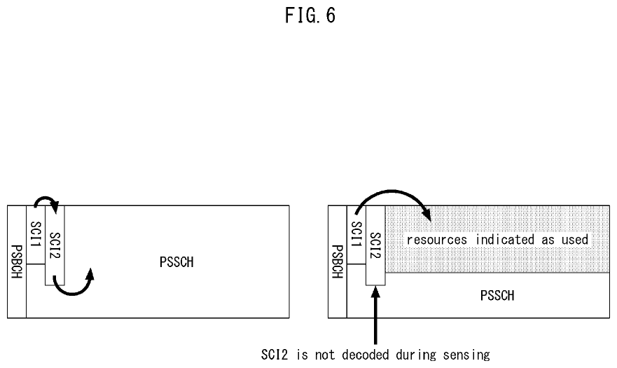

FIG. 6 is a conceptual diagram illustrating a first exemplary embodiment of a two-stage SCI structure.

Referring to FIG. 6, a wireless communication system may support a two-stage SCI structure for efficient resource sensing of a terminal. The two-stage SCI may include a first-stage SCI (i.e., 1st-stage SCI format or SCI format 1-A) indicating allocated resource(s) and a second-stage SCI (i.e., 2nd-stage SCI format or SCI format 2-A/2-B) including information for demodulation of a data channel. The two-stage SCI structure may reduce complexity of the terminal performing resource sensing, and may eliminate a need for blind decoding for multiple aggregation levels. In addition, terminals performing resource sensing may greatly reduce resource sensing complexity and/or power consumption by demodulating only a first-stage SCI including resource allocation information for a PSSCH.

The first-stage SCI may include at least one information element among priority information, frequency resource assignment information, time resource assignment information, resource reservation period information, DMRS pattern information, second-stage SCI format information, beta_offset indicator, the number of DMRS ports, modulation and coding scheme (MCS) information, or combinations thereof.

The second-stage SCI may include at least one information element among a HARQ processor identifier (ID), redundancy version (RV), source ID, destination ID, CSI request information, zone ID, communication range requirements, or combinations thereof. An SCI format 2-C may be used for decoding of a PSSCH and/or providing inter-UE coordination information.

In a sidelink-based communication system, a terminal operating in the resource allocation mode 2 may receive various parameters required for performing a resource selection procedure from a higher layer of a base station. Specifically, the following configuration information may be provided from the higher layer of the base station to the terminal.

Configuration information 1) A resource selection procedure for PSSCH/PSCCH transmission may be triggered at a specific time, for example, a slot n by the higher layer of the base station serving the terminal. In this case, the higher layer of the base station may provide information on the following parameters for PSSCH/PSCCH transmission to the terminal.

A resource pool from which a transmission resource is to be reported

L1 priority prior_{TX}

Remaining packet delay budget (PDB)

The number L_{subCH} of subchannels to be used for PSSCH/PSCCH transmission

(Optional) transmission resource reservation period P_{rsvp_TX} (ms)

If the higher layer of the base station requests the terminal to determine resource subset(s) from which a transmission resource for a PSSCH/PSCCH is to be selected, as a part of re-evaluation or pre-emption check, a higher layer signaling of the base station may provide the following resource sets.

A set of resources for re-evaluation (r₀,r₁,r₂, . . . )

A set of resources for pre-emption (r′₀,r′₁,r′₂, . . . )

The terminal may determine resource subset(s) before and after a time point r″ᵢ−T₃ according to the request from the higher layer of the base station.

r″ᵢ may correspond to the smallest slot index among (r₀,r₁,r₂, . . . ) and (r′₀,r′₁,r′₂, . . . ).

T₃ may be equal to T_{proc,1}

Configuration information 2) For the above-described resource selection procedure, the following higher layer parameters of the base station may be configured or predefined in the terminal.

sl-SelectionWindowList: resource selection window length value

sl-ThresPSSCH-RSRP-List: configuration information of an RSRP threshold according to a priority combination of the transmitting terminal and the receiving terminal

sl-RS-ForSensing: configuration of an RS to be used for sensing, whether to use an RSRP of a PSSCH or an RSRP of a PSCCH

sl-ResourceReservePeriodList: A list of resource reservation period values (up to 16 values may be configured for each resource pool)

sl-SensingWindow: Sensing window length value

sl-TxPercentageList: A parameter X value for a given prior_{TX}. X is a ratio of candidate resources available for transmission within a resource selection window after resource selection

sl-PreemptionEnable: If the parameter sl-PreemptionEnable is set to ‘enable’, an internal parameter priorₚᵣₑ may be set to a priority value configured by the higher layer of the base station.

When a resource selection procedure is triggered in the slot n for the terminal operating in the resource allocation mode 2 in the sidelink-based communication system, the terminal may perform the resource selection procedure as follows.

Step 1) A candidate resource set R_{x,y} may be determined. Within a resource pool configured in the terminal, R_{x,y} may be defined as comprising a t_{y}-th slot in the time domain and L_{subCH} subchannels (i.e., x,x+1,x+2, . . . ,x+L_{subCH}) starting at the x-th subchannel. The terminal may determine the candidate resource set corresponding to R_{x,y} present in the resource pool within the entire time of [n+T₁,n+T₂] corresponding to the resource selection window. In this case, T₁ and T₂ may be defined as follows.

T₁ may a value that satisfies 0≤T₁≤T_{proc,1}, and may be determined by the terminal as an implementation. Here, according to a subcarrier spacing μ_{SL}, T_{proc,1} may be defined as a value as shown in Table 1 below.

TABLE 1

| μ_{SL} | T_{proc,1} [slots] |
|---|---|
| 0 | 3 |
| 1 | 5 |
| 2 | 9 |
| 3 | 17 |

If a value of T₂ₘᵢₙ is smaller than the remaining PDB, the terminal may determine a value of T₂ as a value satisfying T₂ₘᵢₙ≤T₂≤the remaining PDB. On the other hand, if the value of T₂ₘᵢₙ is greater than or equal to the remaining PDB, the terminal may determine the value of T₂ as the remaining PDB.

The number of candidate resources in the candidate resource set determined through Step 1 above may be defined as Mₜₒₜₐₗ.

Step 2) A sensing window may be determined. The sensing window may be defined as [n−T₀, n−T_{proc,0}]. In this case, T₀ may correspond to a value set by the parameter sl-SensingWindow from the higher layer of the base station, and T_{proc,0} may be defined as a value as shown in Table 2 below according to the subcarrier spacing μ_{SL}. The terminal may monitor a PSCCH in slots corresponding to the resource pool within the sensing window, and may measure an RSRP for the PSCCH and/or PSSCH. In this case, a resource used by the corresponding terminal for its transmission within the sensing window may be excluded from the sensing.

TABLE 2

| μ_{SL} | T_{proc,0}^{SL} [slots] |
|---|---|
| 0 | 1 |
| 1 | 1 |
| 2 | 2 |
| 3 | 4 |

Step 3) The terminal may determine initial threshold parameter Th(pi,pj). The value of Th(pi,pj) may be determined as the i-th value configured by the parameter sl-ThresPSSCH-RSRP-List, and in this case, i may be defined as i=pi+(pj−1)·8.

Step 4) The terminal may initialize a resource set S_{A}. In this case, the resource set S_{A} may be initialized to have all possible candidate resources (i.e., R_{x,y}).

Step 5) The terminal may exclude a candidate resource that satisfies the following conditions from the resource set S_{A}.
When the terminal did not monitor a slot tₘ in Step 2.
When it is assumed that the first SCI format (or SCI format 1-A) is received in the slot tₘ that the terminal does not monitor, and it is assumed that slots corresponding to a period value indicated by a resource reservation period field of the first SCI format among period values configured by the higher layer parameter sl-ResourceReservePeriodList of the base station for the resource pool and all subchannels within the resource pool are resource-allocated, a case when at least one condition of Step 6 is satisfied.

Step 6) The terminal may exclude a candidate resource R_{x,y} that satisfies the following condition from the resource set S_{A}.
When the terminal received the first SCI format in the slot tₘ, the resource reservation field of the first SCI format indicates P_{rsvp_RX}, and the ‘priority’ field thereof indicates prio_{RX}.
When an RSRP of the first SCI format is larger than Th(prio_{RX},prio_{TX}), resources overlapping with candidate resources R_{x,y+j×P}_{_{rsvp_TX}} (j=0,1, . . . ,Cᵣₑₛₑₗ−1) among RB sets and/or slots determined by the first SCI format considered as received in the slot t_{m+q×P}_{_{rsvp,RX}} (q=1,2, . . . ,Q) according to the first SCI format received in the slot tₘ or a period value indicated by the resource reservation period field thereof. Here, Q may be defined as

$$Q = ⌈ \frac{{T}_{s c a l}}{{P}_{rsvp \_ RX}} ⌉ ,$$

and T_{scal} may be a value obtained by converting the resource selection window length T₂ in msec units.

Step 7) If the number of remaining candidate resources in the resource set S_{A} is less than X·Mₜₒₜₐₗ, the terminal may increase Th(pi,pj) value by 3 dB (decibel), and may re-perform the procedure from Step 4.

The terminal may report the resource set S_{A} determined through the above procedure to the higher layer of the base station.

If an arbitrary resource rᵢ within the resources for re-evaluation (r₀,r₁,r₂, . . . ) is not included in the resource set S_{A} selected through the above procedure, the terminal may report re-evaluation of the resource rᵢ to the higher layer of the base station.

If an arbitrary resource rᵢ within the resources for pre-emption (r′₀,r′₁,r′₂, . . . ) is not included in the resource set S_{A} by being excluded according to Step 6 and satisfies at least one of the following conditions, the terminal may report pre-emption of the resource r′ᵢ to the higher layer of the base station.
When the parameter sl-PreemptionEnable is set to ‘enable’ and ‘prio_{TX}>prio_{RX}’ is satisfied
When the parameter sl-PreemptionEnable is set but not set to ‘enable’ and both of ‘prio_{RX}<prioₚᵣₑ’ and ‘prio_{TX}<prio_{RX}’ are satisfied

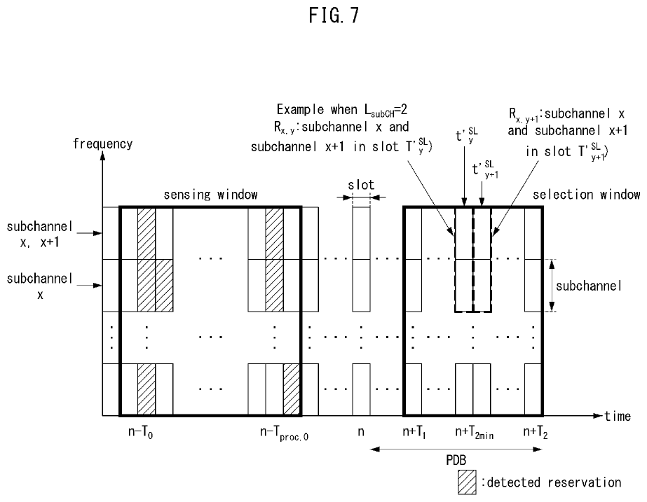

FIG. 7 is a conceptual diagram illustrating a first exemplary embodiment of a part of a resource sensing and/or resource selection procedure of a terminal operating in the sidelink resource allocation mode 2.

Referring to FIG. 7, for example, when L_{subCH} is 2, the terminal may determine a candidate resource R_{x,y} to be the subchannel x and the subchannel x+1 in the slot t′_{y}^{SL}, and the terminal may determine a candidate resource set R_{x,y+1} to be the subchannel x and the subchannel x+1 in the slot t′_{y+1}^{SL}. In this case, the terminal performing the above-described resource sensing and/or resource selection procedure may need to continuously perform PSCCH monitoring for resource sensing. In addition, the terminal performing resource sensing and/or resource selection may need to continuously perform RSRP measurement for PSCCH and/or PSSCH. Therefore, there is a disadvantage in that the power consumption of the terminal may occur significantly.

Hereinafter, in order to improve the complexity of resource sensing and/or resource selection and reduce power consumption of the terminal operating in the sidelink resource allocation mode 2, a more efficient resource sensing and/or resource selection procedure will be proposed through specific exemplary embodiments.

In an exemplary embodiment, the terminal may receive configuration information on a resource pool for sidelink transmission/reception through higher layer signaling of the base station. In addition, a resource sensing type to be performed by the terminal for the corresponding resource pool may be additionally configured. The resource sensing type may include, for example, at least one or more than one of the following resource sensing types.

Resource Sensing Types

Full sensing: it may refer to a scheme of performing resource sensing for the entire sensing period. Basically, the terminal may always perform sensing.

Partial sensing: it may refer to a scheme of performing resource sensing for a partial time period within the sensing period.

Periodic-based partial sensing: it may refer to a scheme of periodically performing resource sensing for a partial time period within the sensing period.

Contiguous partial sensing: it may refer to a scheme of continuously performing resource sensing within the sensing period.

Random selection: it may refer to a scheme of omitting resource sensing and randomly selecting a resource.

The terminal may receive information on a sensing type of a specific resource pool through higher layer signaling of the base station, and may control and perform a resource sensing operation as described above based on the configured sensing type. The above-described sensing type information may include at least one of full sensing information, partial sensing information, periodic-based partial sensing information, contiguous partial sensing information, and random resource selection information.

Hereinafter, ‘configuration’ may include both configuration and pre-configuration.

Hereinafter, ‘selection’ may include both selection and re-selection.

In an exemplary embodiment of the present disclosure, the terminal may perform resource sensing only for some sensing occasions having a specific periodicity with respect to a resource pool for which partial sensing or periodic-based partial sensing is configured. When the terminal performs resource sensing only for some sensing occasions having a specific periodicity, it may be referred to as the ‘periodic-based partial sensing’. Through this, the terminal may significantly reduce sensing complexity and/or power consumption by reducing the number of sensing compared to performing contiguous resource sensing for the entire sensing window according to the convention art.

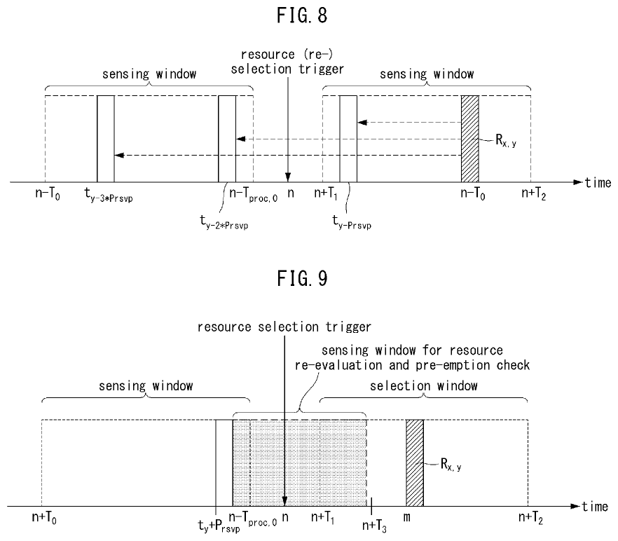

FIG. 8 is a conceptual diagram illustrating a first exemplary embodiment of a periodic-based partial sensing method.

Referring to FIG. 8, in order to determine whether the terminal can use an arbitrary candidate resource R_{x,y} (i.e., a candidate resource of a slot t_{y} in the time domain) within a resource selection window, the terminal may perform sensing on slot(s) having a specific periodicity (e.g., slots t_{y-k×P}_{ᵣₛᵥₚ}(k=1,2,3, . . . )). Here, in a method of determining t_{y-k×P}_{ᵣₛᵥₚ}(k=1,2,3, . . . ), a value of Pᵣₛᵥₚ may be determined as follows.

If there is no configuration information on Pᵣₛᵥₚ, the terminal may consider all period values within a period value set configured by the higher layer parameter sl-ResourceReservePeriodList of the base station for a resource pool for which the terminal intends to perform resource selection as the value of Pᵣₛᵥₚ For example, if Pset={Period #1, Period #2} is configured as resource reservation period information in a configured resource pool #1, the terminal may perform resource sensing on slots t_{y-k×Period #1} by regarding Pᵣₛᵥₚ as Period #1 and perform resource sensing on slots t_{y-k×Period #2} by regarding Pᵣₛᵥₚ as Period #2.

Alternatively, values of Pᵣₛᵥₚ may be (pre-)configured in the terminal. In this case, the values of Pᵣₛᵥₚ may be configured as a subset of the period value set configured by the higher layer parameter sl-ResourceReservePeriodList of the base station for the corresponding resource pool. For example, if Pset={Period #1, Period #2, Period #3} is configured as resource reservation period information for the configured resource pool #1, one value or a plurality of values in the Pset may be configured to the terminal as the values of Pᵣₛᵥₚ for periodic-based partial sensing. For example, Pᵣₛᵥₚ {Period #1, Period #2} may be configured to the terminal. In this case, the terminal may perform resource sensing on slots t_{y-k×Period #1} by regarding Pᵣₛᵥₚ as Period #1 and perform resource sensing on slots t_{y-k×Period #2} by regarding Pᵣₛᵥₚ as Period #2.

In a method of determining t_{y-k×P}_{ᵣₛᵥₚ}(k=1,2,3, . . . ), a value of k may be determined as follows.

The terminal may basically sense the most recent sensing occasion (e.g., slot t_{y-P}_{ᵣₛᵥₚ}) before the slot n in which the resource (re-)selection is triggered or the first slot of the candidate resource set (e.g., Y candidate slots).

Alternatively, the value of k may be configured by the higher layer of the base station. One value or a plurality of values may be configured as k. The terminal may perform sensing on slots t_{y-k×P}_{ᵣₛᵥₚ} corresponding to all k values in the configured set for k.

In an exemplary embodiment, the terminal may receive one value or a plurality of values for Pᵣₛᵥₚ for determining the sensing occasions t_{y-k×P}_{ᵣₛᵥₚ} for periodic-based partial sensing of a specific resource pool from the higher layer of the base station. In this case, the configured value set for Pᵣₛᵥₚ may or may not include the same period value as the value P_{rsvp_TX} corresponding to a packet transmission resource reservation period of the terminal. If the same period value as the value P_{rsvp_TX} of the terminal is not included in the value set for Pᵣₛᵥₚ, and accordingly, the terminal does not monitor the slot t_{y-k×P}_{ᵣₛᵥₚ} corresponding to Pᵣₛᵥₚ=P_{rsvp_TX}, there may occur a problem of continuous collision with transmission resources of other terminals desiring transmission according the same resource reservation period. As such, in order to solve the resource collision problem that may occur when the terminal does not perform resource sensing according to the period corresponding to the packet resource reservation period P_{rsvp_TX}, a method corresponding to at least one or a combination of one or more of the following methods may be considered.

[Method 1]

The terminal may expect that a period value corresponding to P_{rsvp_TX} is always configured to be included in the value set for Pᵣₛᵥₚ That is, the terminal may not expect that a value set for P_{rsvp_TX} that does not include a period value corresponding to P_{rsvp_TX} is configured.

[Method 2]

A period value corresponding to P_{rsvp_TX} may or may not be included in the value set for Pᵣₛᵥₚ configured in the terminal. Even when the period value corresponding to P_{rsvp_TX} is not included in the value set for Pᵣₛᵥₚ, the terminal may always perform sensing on a slot corresponding to a slot Pᵣₛᵥₚ=P_{rsvp_TX}.

[Method 3]

Regardless of configuration information for values of Pᵣₛᵥₚ, the terminal may always monitor at least a slot (i.e., slot t_{y-P}_{ᵣₛᵥₚ}) corresponding to the most recent P_{rsvp_TX} before the first slot among the candidate resource set (i.e., Y candidate slots).

In an exemplary embodiment, the terminal may receive a parameter for determining a value of k for determining sensing occasions t_{y-k×P}_{ᵣₛᵥₚ} for periodic-based partial sensing of a specific resource pool from the higher layer of the base station. In order to determine a value of k, a method corresponding to at least one or a combination of one or more of the following methods may be considered.

[Method 4]

The terminal may receive a value of N corresponding to the number of sensing slots from the base station, and based on the received value of N, may perform sensing on a total of N slots, i.e., slots corresponding to t_{y-1×P}_{ᵣₛᵥₚ}, t_{y-2×P}_{ᵣₛᵥₚ}, . . . , T_{y-N×P}_{ᵣₛᵥₚ} If a value of N is not received, the terminal may assume that N=1.

[Method 5]

The terminal may receive a value of N corresponding to the number of sensing slots from the base station, and based on the received value of N, may perform sensing on a total of N+1 slots including a case of k=1, i.e., slots corresponding to t_{y-1×P}_{ᵣₛᵥₚ}, t_{y-2×P}_{ᵣₛᵥₚ}, t_{y-(N+1)×P}_{ᵣₛᵥₚ}. If a value of N is not received, the terminal may assume that N=0.

[Method 6]

The terminal may receive a value of Nₘₐₓ corresponding to the maximum number of sensing slots from the base station, and may perform sensing on N slots equal to or less than the received Nₘₐₓ (N≤Nₘₐₓ), i.e., slots corresponding to t_{y-1×P}_{ᵣₛᵥₚ}, t_{y-2×P}_{ᵣₛᵥₚ}, . . . , t_{y-N×P}_{ᵣₛᵥₚ}. In this case, N may be determined by the terminal as an implementation, and a case of N=1 may always be included. If a value of Nₘₐₓ is not received, the terminal may assume that Nₘₐₓ=1.

[Method 7]

The terminal may receive one value or a plurality of values of k from the base station. For example, k_set (={k₀, k₁, k₂, k₃}) may be received, and accordingly, the terminal may perform sensing on the slots t_{y-k}_{₀}_{×P}_{ᵣₛᵥₚ}, t_{y-k}_{₁}_{×P}_{ᵣₛᵥₚ}, t_{y-k}_{₁}_{×P}_{ᵣₛᵥₚ}, and t_{y-k}_{₃}_{×P}_{ᵣₛᵥₚ}. In this case, the configured k_set may always include a value of k=1. If the value set for k is not configured, the terminal may perform sensing only on the slot corresponding to k=1.

[Method 8]

The terminal may receive one value or a plurality of values of k from the base station. The terminal may perform sensing on slots corresponding to the values of k in the received value set for k and a slot corresponding to k=1. For example, if the terminal receives k_set (={k₁, k₂, k₃}), the terminal may perform sensing on the slots t_{y-1×P}_{ᵣₛᵥₚ}, t_{y-k}_{₁}_{×P}_{ᵣₛᵥₚ}, t_{y-k}_{₂}_{×P}_{ᵣₛᵥₚ}, and t_{y-k}_{₃}_{×P}_{ᵣₛᵥₚ}. If the value set for k is not received, the terminal may perform sensing only on the slot corresponding to k=1.

In an exemplary embodiment, the terminal may determine a partial resource set that can be used for transmission among candidate resources existing within the resource selection window through periodic-based partial resource sensing. In this case, the resource subsets may be determined before and after a time point m−T₃, and m may correspond to the smallest slot index among the slots for re-evaluation (r₀, r₁, r₂, . . . ) and the slots for pre-emption (r′₀, r′₁, r′₂, . . . ).

More specifically, the terminal may exclude some candidate resources through the above-described Step 5 and Step 6 based on the result of periodic-based partial resource sensing from the initial candidate resource set S_{A} existing within the selection window. Before transmitting a packet in a resource determined to be suitable for transmission through the periodic-based partial resource sensing, the terminal may additionally perform a re-evaluation or preamble check procedure for the corresponding resource.

For example, when the terminal selects a candidate reservation resource of the slot m through the resource sensing and/or selection procedure, the terminal may perform an additional sensing operation for determining whether the selected resource of the slot m can be actually used for transmission at a time point earlier than the slot m.

FIG. 9 is a conceptual diagram illustrating a first exemplary embodiment of a sensing method for resource re-evaluation and/or pre-emption check.

Referring to FIG. 9, according to periodic-based partial resource sensing, the terminal may perform sensing on a slot t_{y-k×P}_{ᵣₛᵥₚ}, and based on a result of the sensing, may initially select a candidate reserved resource R_{x,y}), of the slot m. The terminal may perform a sensing procedure for re-evaluation or pre-emption check before performing transmission with the candidate reserved resource of the slot m. In this case, a method of determining a sensing window for the re-evaluation or pre-emption check is required.

In an exemplary embodiment, the terminal performing periodic-based partial resource sensing may determine the resource sensing window for re-evaluation or pre-emption check by a method corresponding to at least one or a combination of one or more of the following methods.

[Method 9]

The terminal may not perform re-evaluation or pre-emption check on a candidate reservation resource selected by performing periodic-based partial resource sensing.

[Method 10]

The terminal may perform re-evaluation or pre-emption check on a candidate reservation resource selected by performing periodic-based partial resource sensing. A sensing window for re-evaluation or pre-emption check may be defined as a time period from a slot corresponding to a sensing occasion where the periodic-based partial sensing is last performed to a slot corresponding to a specific time point before the slot m of the candidate reservation resource for which the re-evaluation or pre-emption check is to be performed. For example, when a slot in which the most recent periodic-based partial resource sensing is performed is l, and the candidate reserved resource is the slot m, a time period corresponding to [l, m−T₃] may correspond to the sensing window. In this case, l may be defined as l=m P_{rsvp,min} according to the periodic-based partial resource sensing, where P_{rsvp,min} may correspond to a minimum value among resource reservation periods at which the terminal intends to perform periodic-based resource sensing.

[Method 11]

The terminal may receive parameter values for contiguous partial sensing through higher layer signaling of the base station. For example, the terminal may be configured to perform contiguous partial sensing during a time period corresponding to [n+T_{A},n+T_{B}], and may receive parameter values T_{A} and T_{B} therefor. In this case, a sensing window for re-evaluation or pre-emption check may be defined as [n+T_{A},n+T_{B}].

[Method 12]

The terminal may receive parameters for contiguous partial sensing through higher layer signaling of the base station. For example, the terminal may be configured to perform contiguous partial sensing during a time period corresponding to [n+T_{A},n+T_{B}], and may receive parameters therefor. In this case, a sensing window for re-evaluation or pre-emption check may be defined as a time period from a slot corresponding to a sensing occasion where periodic-based partial sensing is last performed to a slot n+T_{B} which is the last sensing window slot configured for contiguous partial sensing. For example, when a slot in which the most recent periodic-based partial resource sensing is performed is l, a time period corresponding to [l, m−T₃] may correspond to the sensing window.

[Method 13]

The terminal may perform re-evaluation or pre-emption check on a candidate reservation resource selected by performing periodic-based partial sensing. A length of a sensing window for re-evaluation or pre-emption check may be preset or selected as a fixed value. For example, the terminal may receive a length W of the sensing window for re-evaluation or pre-emption check from the higher layer of the base station. As another example, the length W of the sensing window for re-evaluation or pre-emption check may be fixed to 32 slots. As yet another example, the terminal may receive a value of W value for the sensing window for re-evaluation or pre-emption check from the higher layer of the base station, and if it does not receive a value of W value, the terminal may regard it as W=32 slots.

In another exemplary embodiment of the present disclosure, the terminal may perform resource sensing only on sensing occasion(s) existing within a time window with respect to a resource pool configured for partial sensing or contiguous partial sensing. It may be referred to as ‘contiguous partial sensing’ that the terminal performs resource sensing only on sensing occasion(s) existing within the time window. Through this, the terminal may significantly reduce sensing complexity and/or power consumption by reducing the number of sensing times compared to performing the conventional contiguous resource sensing for the entire sensing window.

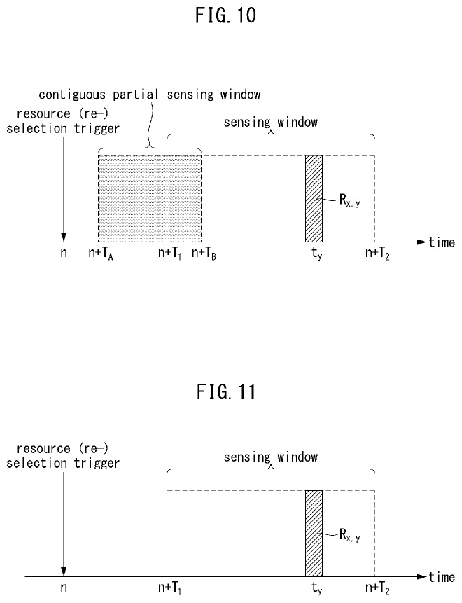

FIG. 10 is a conceptual diagram illustrating a first exemplary embodiment of a contiguous partial sensing method.

Referring to FIG. 10, the terminal may receive a resource selection trigger in a slot n from the higher layer of the base station, and perform sensing for a time period corresponding to [n+T_{A},n+T_{B}] to determine whether candidate resources existing within a selection window are available. In this case, the parameters T_{A} and T_{B}, which are required for contiguous partial sensing, may be positive or negative, or may be set to a value of 0.

In an exemplary embodiment, the terminal may perform a contiguous partial sensing operation when a trigger is received from the higher layer of the base station. As an example, whether or not to perform contiguous partial sensing with respect to a resource pool configured for partial sensing may be notified to the terminal from the higher layer of the base station. In this case, whether to perform contiguous partial sensing may be provided to the terminal from the higher layer of the base station as a part of parameters for triggering resource selection. That is, the following information may be additionally included in the above-described Configuration information 1).
(Optional) whether to perform contiguous partial sensing (e.g., enable/disable)

A message triggering the contiguous partial sensing described above may be transmitted from the higher layer of the base station to the terminal at a time point the same as or a time point (e.g., a time point corresponding to a slot n+T_{B}−T_{proc}, where T_{proc} may be defined as a specific processing time) earlier than the slot n triggering the resource selection. Through this, even when the values T_{A} and T_{B} are negative, the terminal may perform sensing in advance before the slot n.

As an example, the terminal notified to perform (e.g., enable) contiguous partial sensing may perform sensing for a time period corresponding to [n+T_{A},n+T_{B}], and may select a resource based on a result of the sensing.

As an example, the terminal notified not to perform (e.g., disable) contiguous partial sensing may perform only periodic-based partial sensing without performing contiguous partial sensing, and may select a resource based on a result of the periodic-based partial sensing. In this case, the contiguous partial sensing operation may be performed for re-evaluation and/or pre-emption check as in [Method 11] and [Method 12] of the first exemplary embodiment.

In an exemplary embodiment, the parameters T_{A} and T_{B}, which are required for contiguous partial sensing, may be preconfigured through higher layer signaling of the base station. If T_{A} or T_{B} is set to a negative value, the terminal may predict the slot n in which resource selection will be triggered and sense the sensing window of [n+T_{A},n+T_{B}] before the triggering.

In an exemplary embodiment, the parameters T_{A} and T_{B} for contiguous partial sensing may be notified to the terminal from the higher layer of the base station. In this case, the values T_{A} and T_{B} may be provided to the terminal as a part of parameters together with the higher layer message of the base station triggering resource selection. Through this, the terminal may perform resource sensing by selecting appropriate values for T_{A} and T_{B} according to a traffic situation. The above-mentioned values T_{A} and T_{B} may be transmitted from the higher layer of the base station to the terminal at a time point the same as or a time point (e.g., a time point corresponding to a slot n+T_{B}−T_{proc}, where T_{proc} may be defined as a specific processing time) earlier than the slot n triggering the resource selection. Through this, even when the values T_{A} and T_{B} are negative, the terminal may perform sensing in advance before the slot n.

In another exemplary embodiment of the present disclosure, the terminal may transmit data by autonomously selecting a resource without resource sensing. The scheme in which the terminal autonomously selects a resource without resource sensing and transmits data may be referred to as a ‘random resource selection method’. The terminal may greatly reduce power consumption by omitting resource sensing for resource selection.

FIG. 11 is a conceptual diagram illustrating a first exemplary embodiment of a random resource selection method.

Referring to FIG. 11, when a resource selection trigger occurs in a slot n, the terminal may autonomously select a resource to be used for transmission among candidate resources within a resource selection window to perform data transmission.

According to an exemplary embodiment, in order to solve a resource collision problem between a terminal that selects and transmits a transmission resource through random resource selection without performing sensing and other terminals that select and transmit a resource by performing sensing, a priority of the terminal performing the random resource selection may be controlled to a specific value. According to Step 6 and the pre-emption procedure described above, the terminal performing resource sensing may exclude some unsuitable resources from a candidate resource set based on a priority. For example, when it is determined that a transmission resource reserved by a transmitting terminal having a relatively low priority (e.g., a terminal whose prio_{TX} is set to a relatively high value) through resource sensing overlaps a transmission resource of a terminal having a relatively high priority (e.g., a transmission resource occupied by an SCI format in which prio_{TX} is set to a relatively low value), the transmitting terminal may not use the reserved transmission resource according to the pre-emption, and perform transmission using another resource through resource re-selection. Accordingly, since transmission avoiding a resource collision is possible according to the priorities between terminals having capability to perform sensing, collisions between transmission resources can be reduced as much as possible.

For convenience of description, a terminal having capability to perform sensing may be referred to as a ‘terminal S’, and a terminal without capability to perform sensing may be referred to as a ‘terminal N’.

Since the terminal N does not have capability to perform sensing, it may select a transmission resource through random resource selection. In this case, the terminal N cannot determine whether the resource selected by the terminal N collides with another terminal. If a priority of the terminal S is lower than that of the terminal N, the terminal S having the resource sensing capability may avoid a resource collision by performing transmission using another resource without using the resource through resource reselection. However, if the priority of the terminal S is higher than the priority of the terminal N, the terminal S may perform transmission without performing resource reselection because its own priority is higher. Since the terminal N does not have the sensing capability, it cannot transmit by avoiding the resource occupied by the terminal S, and thus a resource collision between the terminal S and the terminal N may occur.

As described above, in order to solve the resource conflict problem between the terminal S and the terminal N, a method corresponding to at least one or a combination of one or more of the following methods may be considered.

[Method 14]

The priority of terminal N may always be set to the highest. That is, a priority field of the first SCI format transmitted by the terminal N may always indicate the smallest value (i.e., priority value 1, 0, or ‘000’).

[Method 15]

Whether the corresponding transmission is a transmission of the terminal N may be indicated through the first SCI format. This may be referred as ‘sensing indicator’. For example, the terminal N may indicate through a specific field of the first SCI format that a resource occupied by the SCI transmitted by the terminal N corresponds to a resource selected by the terminal N having no sensing capability through random resource selection. As an example, the first most significant bit (MSB) or the first least significant bit (LSB) of a reserved field in the first SCI format may be used as being interpreted as the sensing indicator. The presence or absence of the sensing indicator in the first SCI format may be configured to the terminal as part of resource pool configuration.

In an exemplary embodiment, the terminal S may detect the first SCI format of another terminal through resource sensing. When the sensing indicator field of the detected first SCI format indicates that the SCI indicates a resource occupied through random resource selection without resource sensing (i.e., the detected first SCI format is an SCI of the terminal N), and the resource occupied by the SCI collides with a resource occupied by the terminal S, the terminal S may reselect another resource by avoiding the existing resource regardless of a priority value indicated by the corresponding SCI.

In an exemplary embodiment, the terminal S may detect the first SCI format of another terminal through resource sensing. When the sensing indicator field of the detected first SCI format indicates that the SCI indicates a resource occupied through random resource selection without resource sensing (i.e., the detected first SCI format is an SCI of the terminal N), and the resource occupied by the SCI collides with a resource occupied by the terminal S, the terminal S may reinterpret a priority value indicated by the SCI by adding Δ to the priority value. That is, the terminal S may determine pror′_{RX}=prior_{RX}+Δ. In this case, Δ may correspond to a preset value, a predefined fixed value, or a value indicated by the first SCI format. If a value of A is indicated by the first SCI format, the value of Δ may be indicated by reinterpreting a specific field of the first SCI format. For example, N bits of the MSB (or LSB) of the ‘reserved’ field of the first SCI format may be interpreted as the ‘sensing indictor’ and/or a ‘Δ value indicator’. The terminal S may determine whether to reselect a resource based on the value pror′_{RX}.

In an exemplary embodiment, the terminal S may detect the first SCI format of another terminal through resource sensing. When the sensing indicator field of the detected first SCI format indicates that the SCI indicates a resource occupied through random resource selection without resource sensing (i.e., the detected first SCI format is an SCI of the terminal N), and the resource occupied by the SCI collides with a resource occupied by the terminal S, the terminal S may determine whether to reselect a resource based on a priority value indicated by the corresponding SCI. If the priority of the terminal N is higher than that of the terminal S, the terminal S may perform resource reselection according to pre-emption of the occupied resource. If the priority of the terminal N is lower than that of the terminal S, the terminal S may determine whether to perform resource reselection according to the pre-emption of the occupied resource by implementation. That is, depending on the implementation, the terminal S may use the occupied resource for transmission as it is without avoiding the occupied resource, or may avoid the occupied resource and reselect another resource for transmission.

According to the present disclosure, a method for a terminal operating in the sidelink resource allocation mode 2 in a V2X communication environment to more efficiently perform resource sensing and a signaling and/or resource selection method required therefor may be provided.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a first terminal, comprising:
receiving, from a base station, resource pool configuration information including information on a resource sensing type;
in response to that the information on the resource sensing type indicates a sensing operation, measuring a received power of a physical sidelink control channel (PSCCH);
in response to that the received power of the PSCCH is equal to or greater than a threshold value, receiving, from a second terminal, sidelink control information (SCI) including scheduling information;
sensing transmission resource(s) within a sensing period according to the resource sensing type based on the scheduling information and a measurement result of the received power;
selecting a first resource based on a result of the sensing on the transmission resource(s); and
performing sidelink communication using the selected first resource.

2. The method according to claim 1, wherein the resource pool configuration information further includes information on at least one period value associated with the sensing period, and the sensing of the transmission resource(s) within the sensing period according to the resource sensing type based on the scheduling information and the measurement result of the received power comprises: in response to that the information on the resource sensing type indicates periodic-based partial sensing, performing resource sensing partially within the sensing period based on the at least one period value.

3. The method according to claim 1, wherein the resource pool configuration information further includes information on at least one period value associated with the sensing period and information on a number of sensing slots associated with each of the at least one period value, and the sensing of the transmission resource(s) within the sensing period according to the resource sensing type based on the scheduling information and the measurement result of the received power comprises: in response to that the information on the resource sensing type indicates periodic-based partial sensing, performing resource sensing partially within the sensing period based on the at least one period value and the number of sensing slots associated with each of the at least one period value.

4. The method according to claim 3, further comprising, after the selecting of the first resource based on the result of the sensing on the transmission resource(s), performing a re-evaluation operation on the first resource, wherein the re-evaluation operation is performed in a time period associated with a minimum value of the at least one period value and a slot of the first resource.

5. The method according to claim 1, wherein the resource pool configuration information further includes information on a first value and a second value indicating a sensing period, and the sensing of the transmission resource(s) within the sensing period according to the resource sensing type based on the scheduling information and the measurement result of the received power comprises: in response to that the information on the resource sensing type indicates contiguous partial sensing, performing resource sensing continuously within a first slot associated with the first value to a second slot associated with the second value.

6. The method according to claim 1, further comprising, after the selecting of the first resource based on the result of the sensing on the transmission resource(s), performing a re-evaluation operation on the first resource, wherein the re-evaluation operation is a contiguous partial sensing operation on the first resource.

7. The method according to claim 1, further comprising, when the SCI includes information on a second resource selected by the second terminal and information on a priority of the second terminal,
in response to that the information on the resource sensing type indicates random resource selection, arbitrarily selecting a third resource;
determining whether a collision exists between the second resource and the third resource; and
in response to determining that a collision exists between the second resource and the third resource and a preset priority of the first terminal is lower than the priority of the second terminal, selecting a fourth resource different from the third resource,
wherein the priority of the second terminal is associated with whether or not the second terminal performs sensing.

8. The method according to claim 1, further comprising, when the SCI includes information on a second resource selected by the second terminal and an indicator of whether or not the second terminal performs sensing,
in response to that the information on the resource sensing type indicates random resource selection, arbitrarily selecting a third resource;
determining whether a collision exists between the second resource and the third resource; and
in response to determining that a collision exists between the second resource and the third resource and the indicator indicates that the second resource is a resource selected by the random resource selection, selecting a fourth resource different from the third resource.

9. A first terminal comprising:
a processor; and
a memory storing one or more instructions executable by the processor,
wherein the one or more instructions are executed to:
receive, from a base station, resource pool configuration information including information on a resource sensing type;
in response to that the information on the resource sensing type indicates a sensing operation, measure a received power of a physical sidelink control channel (PSCCH);
perform monitoring on the PSCCH based on the resource pool configuration information;
in response to that the received power of the PSCCH is equal to or greater than a threshold value, receive, from a second terminal, sidelink control information (SCI) including scheduling information;
sense transmission resource(s) within a sensing period according to the resource sensing type based on the scheduling information and a measurement result of the received power;
select a first resource based on a result of the sensing on the transmission resource(s); and
perform sidelink communication using the selected first resource.

10. The first terminal according to claim 9, wherein the resource pool configuration information further includes information on at least one period value associated with the sensing period, and when the information on the resource sensing type indicates periodic-based partial sensing and the transmission resource(s) is sensed within the sensing period based on the scheduling information and the measurement result of the received power, the periodic-based partial sensing is performed within the sensing period based on the at least one period value.

11. The first terminal according to claim 9, wherein the resource pool configuration information further includes information on at least one period value associated with the sensing period and information on a number of sensing slots associated with each of the at least one period value, and when the information on the resource sensing type indicates periodic-based partial sensing and the transmission resource(s) is sensed within the sensing period based on the scheduling information and the measurement result of the received power, the periodic-based partial sensing is performed within the sensing period based on the at least one period value and the number of sensing slots associated with each of the at least one period value.

12. The first terminal according to claim 11, wherein the one or more instructions are further executed to, after the selecting of the first resource based on the result of the sensing on the transmission resource(s), perform a re-evaluation operation on the first resource, wherein the re-evaluation operation is performed in a time period associated with a minimum value of the at least one period value and a slot of the first resource.

13. The first terminal according to claim 9, wherein the resource pool configuration information further includes information on a first value and a second value indicating a sensing period, and when the information on the resource sensing type indicates contiguous-based partial sensing and the transmission resource(s) is sensed within the sensing period based on the scheduling information and the measurement result of the received power, the contiguous partial sensing is performed within a first slot associated with the first value to a second slot associated with the second value.

14. The first terminal according to claim 9, wherein the one or more instructions are further executed to, after the selecting of the first resource based on the result of the sensing on the transmission resource(s), perform a re-evaluation operation on the first resource, wherein the re-evaluation operation is a contiguous partial sensing operation on the first resource.

15. The first terminal according to claim 9, wherein the SCI includes information on a second resource selected by the second terminal and information on a priority of the second terminal, and the one or more instructions are further executed to:
in response to that the information on the resource sensing type indicates random resource selection, arbitrarily select a third resource;
determine whether a collision exists between the second resource and the third resource; and
in response to determining that a collision exists between the second resource and the third resource and a preset priority of the first terminal is lower than the priority of the second terminal, select a fourth resource different from the third resource,
wherein the priority of the second terminal is associated with whether or not the second terminal performs sensing.

16. The first terminal according to claim 9, wherein the SCI includes information on a second resource selected by the second terminal and an indicator of whether or not the second terminal performs sensing, and the one or more instructions are further executed to:
in response to that the information on the resource sensing type indicates random resource selection, arbitrarily select a third resource;
determine whether a collision exists between the second resource and the third resource; and
in response to determining that a collision exists between the second resource and the third resource and the indicator indicates that the second resource is a resource selected by the random resource selection, select a fourth resource different from the third resource.
